(19) United States
(12) Patent Application Publication
(10) Pub. No.: US 2009/0155757 A1
(43) Pub. Date: Jun. 18, 2009

(54) Interactive multimedia instructional systems

(76) Inventors: Sue Gradisar, Corrales, NM (US); Nicole Bunselmeyer, Seattle, WA (US)

Correspondence Address: KNUBOX, PO BOX 30876, SPOKANE, WA, 99223, US

(21) Appl. No.: 12/002,559

(22) Filed: Dec. 18, 2007

(51) Int. Cl. G09B 3/00

(52) U.S. Cl. 434/350

(57) ABSTRACT

The present invention aims at creating an interactive multimedia instructional program that allows inexperienced developers to create multimedia rich and effective learning programs. The present invention uses a commonly used graphics authoring program to pre-program templates that provide instructional frameworks based upon instructional concepts and adult learning theory. A developer uses a template editor to easily modify and customize the instructional templates for a particular use. The final instructional program can be distributed in a wide number of common file formats.

### CROSS REFERENCE TO RELATED APPLICATION

There are no related applications.

### STATEMENT REGARDING FEDERALLY SPONSORED R&D

Not applicable to this application.

### TECHNICAL FIELD

This invention relates to an interactive multimedia instructional system and more particularly to an interactive multimedia instructional system design that allows inexperienced developers to create effective learning programs based upon principles of instructional design and adult learning theory.

### BACKGROUND OF THE INVENTION

Computer based training is well known in the field. Ideally, and according to principles of instructional and adult learning theory, learning is most efficient when it is interactive and guided rather than static and sequential. Computer systems provide an ideal method of presenting information interactively. Today, there are several methods of creating instructional programs.

Sequential presentation programs are widely adopted and incrementally step a learner through a given topic. Typical sequential presentation programs may include PowerPoint (a registered trademark of Microsoft) and the like. These types of programs are fairly simple to use by instructional developers, but are rigid in structure. Most often, they create instruction that starts with an introduction, provides content through a main body, and ends with a summary or conclusion. Sequential presentation programs fail to provide an optimal learning environment. For example, sequential presentations restrict learners from jumping forward to understand an advanced topic in order to reinforce the need of a base topic. Sequential presentations also restrict users from skipping information that is already known and focusing on that which is not.

Another method for creating computer based training is through the use of HTML, or web, based authoring tools. These programs can be interactive and provide multimedia rich content, but can be very difficult for an inexperienced developer to use. Flash (a registered trademark of Adobe) is an excellent example of a web based graphics authoring tool. An inexperienced developer may spend months learning the tool to the level needed to produce high quality and effective media programs. In addition, these tools are not directed at guiding the developer in creating instructional programs based upon adult learning theories. An inexperienced developer is unable to easily and quickly edit preconfigured templates in these types of systems.

Yet another method for creating computer based training is custom learning software programs. An example of such a tool is described by U.S. Pat. No. 7,209,280. These types of systems provide instructionally rich templates, but are expensive and difficult to learn. In addition, these programs easily become dated as they do not utilize industry standard multimedia authoring tools.

In these respects, the interactive multimedia instructional system according to the present invention substantially departs from conventional concepts of the prior art, and in doing so provides an apparatus primarily designed for the purpose of allowing inexperienced developers to create effective learning programs.

### SUMMARY OF THE INVENTION

The present invention therefore aims at creating an interactive multimedia instructional system that allows inexperienced developers to create content-rich and effective learning programs.

The foundation of the interactive multimedia system is a base graphics system. The base graphics system is pre-programmed to create one or more instructional templates that leverage the fundamentals of adult learning theory. The pre-programming may include, but is not limited to creating frames, inserting graphics and videos, creating navigation buttons, etc. The pre-programming stage is generally done by one adept at graphic authoring tools.

A template editor provides the means for an inexperienced developer to modify the instructional templates for a desired instructional program. The template editor is a stand alone program which is designed to be easy to use in comparison to the base graphics system. The result is that someone who has little to no knowledge in the complex base graphics system can easily create instructional programs that leverage and are supported by the complex base graphics system. The output of the template editor is a stand alone instructional program that can be in one of many commonly used formats. The instructional program provides an effective learning system to be used by one or more end users.

These and other features, aspects, and advantages of the present invention will become better understood with regard to the following description, appended claims, and accompanying drawings.

### BRIEF DESCRIPTION OF THE DRAWINGS

Preferred embodiments of the invention are described below with the reference to the following accompanying drawings:

FIG. 1 a block diagram describing the process of creating an interactive multimedia instructional program according to the present invention;

FIG. 2 is a block diagram showing the major components of the present invention;

FIG. 3 is an exemplary main page of an instructional program;

FIG. 4 is an exemplary section page of an instructional program; and,

FIG. 5 is an exemplary sub-section of an instructional program.

### DETAILED DESCRIPTION OF THE PREFERRED EMBODIMENTS

The various embodiments described herein create an interactive multimedia instructional system for allowing a developer to effectively provide instruction to a user. As used herein, the term “user” represents a person, or a group of people, that receive information from the instructional system. The user may include, but is not limited to, students and employees. Also used herein, the term “developer” represents, but is not limited to, someone that enters and customizes the information and content of the instructional system. It should also be understood that the terms “computer” and “software” are general terms that are well known in the art and not to be construed to be limiting. For example, the term “computer” may include laptops, desktops, servers, wireless phones, kiosks and any electronic device that provides interaction with an electronic processor. According to the preferred embodiment of the present invention, a vector and raster based multimedia software system, trademarked “Flash” (a trademark of Adobe), is used and described. Although the multimedia content of the present invention is ideally suited for use with vector and raster based multimedia software systems, the present invention should not be construed to be limited to any particular graphics type software system. Also used herein, an “XML” file is used to present a best practice for controlling the style and formatting of content, but the present invention should not be limited to XML. According to the present invention, XML provides the ability to standardize page formats from a central file or location which can be edited and modified separately from an executable program.

Summary

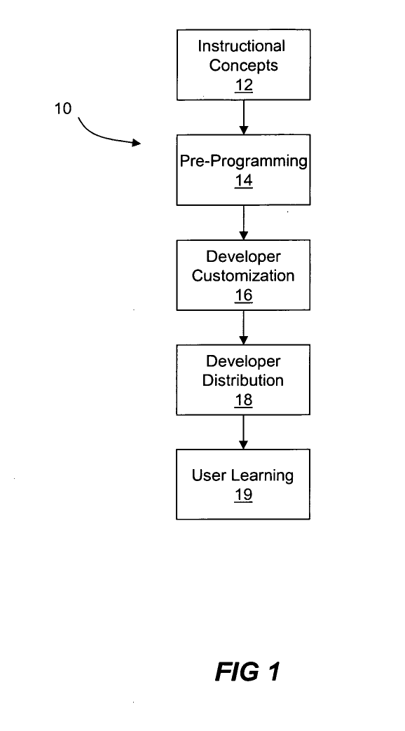

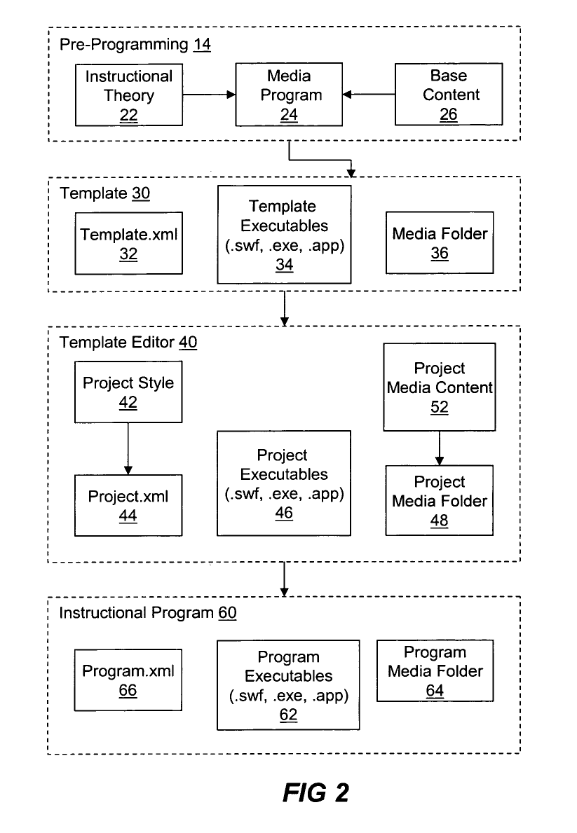

According to the present invention, FIG. 1 and FIG. 2 describe an instructional development process 10 for enabling an inexperienced developer to create effective learning programs. A pre-programming step 14 is performed within a multimedia software authoring program, such as Flash®. A programmer adept in the multimedia authoring tool creates a program template 30 that is optimized for learning based upon a foundation of instructional concepts 12. A customization step 16 is performed by an inexperienced developer that wishes to create an instructional program. The inexperienced developer uses a template editor 40 which edits the program template 30 without the need of the more complex multimedia software authoring program. A developer distribution step 18 is performed within template editor 40 to create an instructional program 60 that can be distributed in multiple formats to one or more end users. The end user interacts with the instructional system through a user learning step 19 on a computer.

Instructional Program

The end goal of process 10 is to create instructional program 60 which is optimized on the principles of adult learning theory. Program 60 provides instruction and content to an end user in a fashion that promotes individual learning.

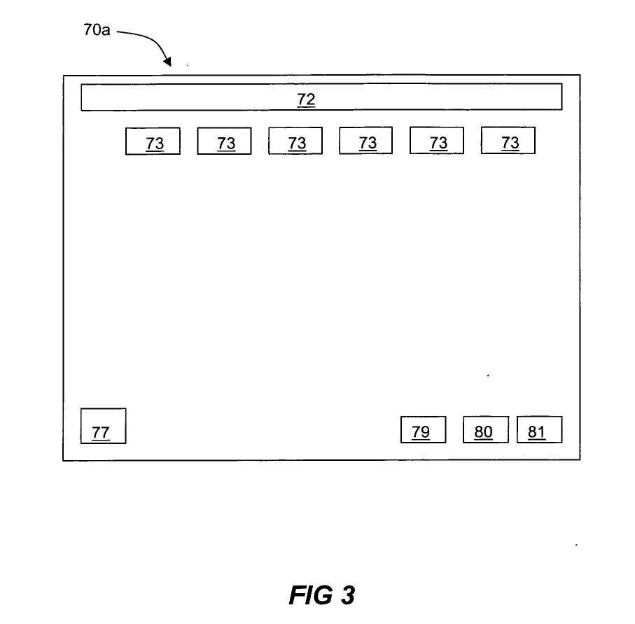

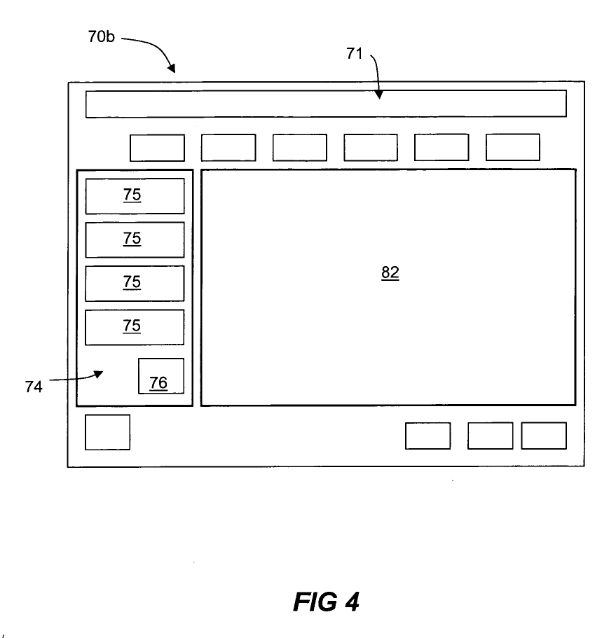

FIG. 3 shows a preferred embodiment of the main page 70a of instructional program 60 according to the present invention. Across the top of the page is a title frame 72 which easily allows the user to know the topic of the program. Below title frame 72 on main page 70a is a section frame that houses a plurality of section buttons 73 that may take the user to different section pages that are relevant to particular topics. For example, clicking an individual button of section buttons 73 may take a user from the main page 70a to a section page 70b of FIG. 4. Buttons 73 allow the user to skip sections that are known and to browse and explore sections that are not known. Title frame 72 and section buttons 73 on main page 70a are always available to users in instructional program 60 and can be accessed from section page 70b and a sub-section page 90.

When the user enters section page 70b, an introduction content 82 to a section topic is presented via media file/s (video or graphic with audio files) and a plurality of sub-section buttons 75 become available on the left side of section page 70b. Just under the plurality of sub-section buttons 75 in each section page 70b is a section web button 76. Web button 76 allows the user to access predetermined information via a web link, such as section-specific reviews, testing, or on-line updates.

User navigation is apparent at all times. Buttons on main page 70a, section page 70b, and sub-section page 90 highlight, and remain highlighted, when selected. As an example, if the user selects an individual button of section buttons 73 and then an individual button of sub-section buttons 75, both selected buttons are highlighted. The highlights change as other buttons are selected.

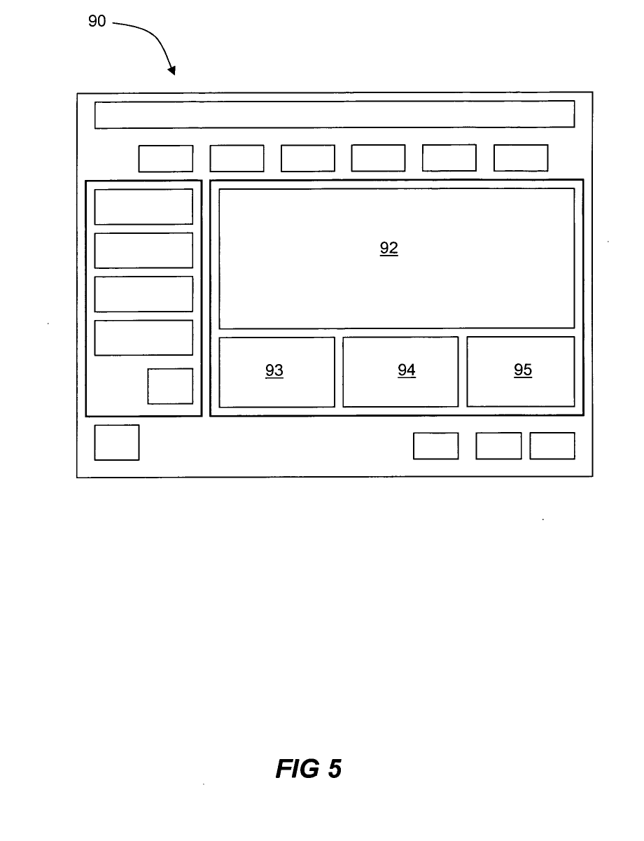

Sub-section buttons 75 take the user to pages that support the current section selected by the user through section buttons 73. For example, sub-section buttons 75 may provide different ways to present the topic of sub-section page 90. Sub-section page 90, of FIG. 5, would provide a more detailed perspective related to the topic.

Introduction content 82 is the focal point of main page 70b. Media file 82 may be a static image, such as, but not limited to, a .gif, tif, .bmp or .jpg type format accompanied by an audio file, such as .mp3, or a video type, such as .flv file. Graphic and video files used in the program are automatically resized to accommodate the program's structure. The purpose of content 82 is to introduce the user to the main topic.

The preferred embodiment of the present invention uses, but is not limited to, .flv files which is a Flash® video file type as it provides good image to file size ratios and can easily be integrated into Flash(D program files. Many common types of video files may be converted to .flv type files through on-line and free conversion programs. The preferred embodiment of the present invention uses, but is not limited to, .mp3 audio files. Many common types of audio files may be converted to .mp3 files through on-line and free conversion programs.

At the bottom left corner of main page 70a is quit button 77. Quit button 77 takes a user to a program credits page (not shown) with options to quit the program or to return the user to the opening media file, which when ends, automatically takes user to 70a.

At the bottom right corner of main page 70a is a program-specific web button 79, a resources button 80, and a print button 81. The program-specific web button 79 allows users to access predetermined information via a web link, such as program-specific reviews, testing, or on-line updates. Resources button 80 allows the user to access another sub page, similar to 70b, which provides the user with section-specific related resources (not shown). The related resources are provided via .swf (Flash generated) files or graphic files. The resources files can include on-line links to the web and can be printed, using print button 81. Print button 81, allows the user to print resources and sections of interest. Buttons 77, 79, 80, 81 are on the main page 70a and are always available to users in instructional program 60 and can be accessed from section page 70b and sub-section page 90.

FIG. 5 shows the preferred embodiment of sub-section page 90 and shows a layout for presenting issues or challenges when the goal is to get the end user to understand multiple perspectives of a topic. Sub-section page 90 utilizes the same navigation bars as section page 70b to maintain the navigational format throughout instructional program 60. A large media file 92 is positioned as the focal point of sub-section page 90 and is supported by three smaller media files, a first media file 93, a second media file 94, and a third media file 95. Media files 92, 93 and 94 provide value-added content, such as expert commentary, multiple perspectives, lessons learned, and promising practices. Again, the media files of sub-section page 90 may be any commonly supported media file, such as graphics image with an mp3 file or a video in the fla format. Although sub-section page 90 of FIG. 5 is shown in a particular format for a particular type of information, it should be appreciated that many other styles of sub-section pages are possible within the spirit of the present invention.

As shown in FIG. 2, instructional program 60 is comprised of program executables 62 in a wide range of commonly used file types including, but not limited to, Windows (a trademark of Microsoft) executable files, Apple® executable files, hypertext markup files (HTML) and FLASH® .swf files, a media program folder 64 and a program xml 66. Program executables 62 are created during pre-programming 14 and reside in template executable 34. Template editor 40 transforms template executable 34 into a project executable 46 and delivers program executables 62. A template xml file 32 and a template media folder 36 can be modified through, and exported from, template editor 40. Program executables 62 reference program xml 66 can draw content from media program folder 64. Once instructional program 60 is created, the developer can make modifications to media files in media program folder 64 without the template editor 40 by utilizing the same file names when replacing files.

Pre-Programming

The purpose of pre-programming step 14 is to offload the challenge of adult learning theory layout and advanced computer programming from the developer. Pre-programming step 14 creates template 30 which contains main page 70a, and one or more versions of section page 70b and one or more versions of sub-section page 90. Template 30 is comprised of template xml file 32 which contains page formatting information, template executable 34 which contains the base program written in the more complex media authoring format (e.g., .swf, .exe, app, .html), and media folder 36 which contains the media files used by template executable 34.

As shown in more detail by FIG. 2, an amount of instructional theory 22 and an amount of base content 26 is brought into a media program 24, such as Flash®. Base content 26 is sample multimedia files that allows the developer to visualize how information should be presented for his/her customized program. The published output of pre-programming 14 creates template 30. The template executables 34 are fixed; the xml 32 and the media folder 36 can be modified.

Template Editor

Through the use of the template editor 40, which is a standalone executable program, the developer can modify template xml 32 and populate the media folder 36. The template executables 34 cannot be modified; the template editor copies the executables into the instructional program 60. Template editor 40 in FIG. 2 combines a project style 42 with project content 52 which is the developer's customized style and content.

The template editor 40 imports the template xml 32 and the media folder 36 directories structure. The developer then uses template editor 40 to modify elements, such as but not limited to, color, alpha, button size, background, button names, and selected text messages to reflect the developer's project style 42. Simultaneously, the developer uses the program editor to populate a media project folder 48. The modifications and media population are all accomplished through a project xml 44.

The developer starts the customization process by installing the template editor 40 on to his/her computer, or by remotely running it from another computer. The template editor 40 allows the developer to see the final product of template 30 and to modify the XML file 32 and media folder 36. The developer customizes the XML file 32 in order to achieve the desired look and feel. The developer then uses the menus of editor 40 to replace the files contained within media folder 36 with their own multimedia content. Publication occurs through the template editor 40 which produces the instructional program 60. Template editor 40 can export files onto a CD, memory stick, or any other common electronic format, or a web page.

### Alternative Embodiments

Alternative to using template editor 40 to edit XML file 32 and media folder 42, a developer may replace media content directly. The process of editing the contents of the media folder 36 without the use template editor 40 requires the developer to have a reasonably-high level of computer skill. Similarly, and with an even higher level of developer skill, the developer may edit XML file 32 directly in order to achieve the desired look and feel of the final instructional program. These methods, although not the preferred method of creating a multimedia instructional system, can be used within the scope and in the spirit of the present invention. Furthermore, these methods provide a simple way to update content and change the look and feel of a distributed program without the requirement of the template editor 40.

While the interactive multimedia instructional system herein described constitutes preferred embodiments of the invention, it is to be understood that the invention is not limited to these precise forms of assemblies and processes, and that changes may be made therein without departing from the scope and spirit of the invention as defined in the appended claims.

We claim:

1. A process for creating a multimedia instructional program comprising:
(A) a pre-programming step wherein a programmer creates an instructional template using a base multimedia authoring tool, said instructional template having a program file, a specification file, and a plurality of template multimedia files;
(B) a first customization step wherein a developer modifies said specification file of said instructional template through the use of a template editor; and,
(C) a publication step wherein said developer uses said template editor to transform said program file, said specification file, and said one or more developer multimedia content files, into said instructional program for use by an end user.

2. The process of creating a multimedia instructional program of claim 1, wherein said specification file is an XML file.

3. The process of creating a multimedia instructional program of claim 1, wherein said base multimedia authoring tool is a vector and raster based multimedia software system.

4. The process of creating a multimedia instructional program of claim 1, wherein said developer multimedia content files include video.

5. A process for creating a multimedia instructional program comprising:
(A) a pre-programming step wherein a programmer creates an instructional template using a base multimedia authoring tool, said instructional template having a program file, a specification file, and a multimedia content folder having a plurality of template multimedia files within;
(B) a first customization step wherein a developer modifies said specification file of said instructional template through the use of a template editor;
(C) a second customization step of said developer using said template editor to replace one or more of said plurality of template multimedia files with on or more developer multimedia content files; and,
(D) a publication step wherein said developer uses said template editor to transform said program file, said specification file, and said multimedia content folder, into said instructional program for use by an end user.

6. The process of creating a multimedia instructional program of claim 5, wherein said specification file is an XML file.

7. The process of creating a multimedia instructional program of claim 5, wherein said base multimedia authoring tool is a vector and raster based multimedia software system.

8. The process of creating a multimedia instructional program of claim 5, wherein said multimedia content folder includes video files.

9. A process for creating a multimedia instructional program comprising:
(A) a pre-programming step wherein a programmer creates an instructional template using a base multimedia authoring tool, said instructional template having a program file, a specification file, and a plurality of template multimedia files;
(B) a first customization step wherein a developer modifies said specification file of said instructional template through the use of a template editor;
(C) a second customization step of said developer replaces one or more of said plurality of template multimedia files with one or more developer multimedia content files;
(D) a publication step wherein said developer uses said template editor to transform said program file, said specification file, and said one or more developer multimedia content files, into said instructional program for use by an end user; and,
E) a revision step wherein said developer, without the use of the template editor, transforms said one or more developer multimedia content files into said instructional program for use by an end user.

10. The process of creating a multimedia instructional program of claim 9, wherein said specification file is an XML file.

11. The process of creating a multimedia instructional program of claim 9, wherein said base multimedia authoring tool is a vector and raster based multimedia software system.

12. The process of creating a multimedia instructional program of claim 9, wherein said developer multimedia content files include video.
